(19) United States
(12) Patent Application Publication
(10) Pub. No.: US 2016/0312930 A1
(43) Pub. Date: Oct. 27, 2016

(54) TUBULAR ASSEMBLY

(71) Applicant: TECHNIP FRANCE, Courbourg (FR)

(72) Inventors: Javad SAFARI, Aberdeen Aberdeenshire (GB); John HAMILTON, Portlethen Aberdeenshire (GB); Sylvain DENNIEL, Aberdeen Aberdeenshire (GB)

(21) Appl. No.: 15/103,698

(22) PCT Filed: Dec. 11, 2014
(86) PCT No.: PCT/IB2014/003047

§ 371 Date: Jun. 10, 2016

(30) Foreign Application Priority Data
Dec. 12, 2013 (GB) 1322008.2

(51) Int. Cl. F16L 13/02; F16L 58/18; B23K 31/02; F16L 58/08

(52) U.S. Cl. CPC F16L 13/0263; F16L 58/08; F16L 58/181; B23K 31/02; B23K 2201/10

(57) ABSTRACT

A tubular assembly (10) for conveying corrosive fluid including a first iron-based tubular (12) having a cladded inner surface (14); and a second iron-based tubular (16) having a cladded inner surface (18). The first tubular (12) is connected to the second tubular (16) using a non-iron based bonding material (20). The tubular assembly (10) includes a first cladding (22) including a corrosion resistant material along the inner surface (14) of the first iron-based tubular (12) and a second cladding (24) including a corrosion resistant material along the inner surface (14) of the first iron-based tubular (12); the second cladding (24) being adjacent the first cladding (22) and proximate an end (38) of the first iron-based tubular (12) connected to the second iron-based tubular (16) by the non-iron based bonding material (20).

The present invention relates to a tubular assembly, in particular, a tubular assembly for conveying corrosive fluid; and a method for manufacturing the same.

The present invention also relates to a method of producing a tubular for a tubular assembly for conveying corrosive fluid.

Tubular assemblies are commonly used in the oil and gas industry to convey fluid from one location to another.

A tubular assembly in the form of a riser, for example a steel catenary riser (SCR), is a common method of attaching an offshore pipeline to a deepwater floating oil production platform.

A SCR is composed of a number of pipe joints connected together by girth welds. The pipe joints may be cladded or non-cladded, however when used to convey very corrosive fluid then the pipe joints are generally of the cladded type.

The cladding is in the form of an internal corrosion resistance alloy (CRA).

Most operators require the cladding to be made of Alloy 625 (UNS N06625) due to its corrosion resistant properties and its ability to increase the fatigue performance of the weld connecting two pipe joints together by preventing cracks from forming near the weld and thereafter propagating towards the weld.

However Alloy 625 can be very expensive in the quantities required to clad a SCR, and there is therefore a need for an improved tubular assembly for conveying corrosive fluid which is cheaper to manufacture while still maintaining the fatigue performance of current SCRs.

It is an object of the invention to provide an improved tubular assembly for conveying corrosive fluid which is cheaper to manufacture while still maintaining the fatigue performance of current SCRs.

According to a first aspect, there is provided a tubular assembly for conveying corrosive fluid comprising:
a first iron-based tubular having a cladded inner surface; and
a second iron-based tubular having a cladded inner surface; the first tubular being connected to the second tubular using a non-iron based bonding material; wherein the tubular assembly comprises a first cladding comprising a corrosion resistant material along the inner surface of the first iron-based tubular and a second cladding comprising a corrosion resistant material along the inner surface of the first iron-based tubular; the second cladding being adjacent the first cladding and proximate an end of the first iron-based tubular connected to the second iron-based tubular by the non-iron based bonding material.

By means of the invention, a tubular assembly for conveying corrosive fluid is provided that is cheaper to manufacture while still maintaining the fatigue performance of current SCRs. By having the cladded inner surface being composed of a first cladding and a second cladding, a more expensive cladding can be positioned where increase fatigue strength is required while a less expensive cladding can be used to line the inner surface of the first tubular, while maintaining the same fatigue performance of a tubular lined across its whole length with the more expensive cladding.

Preferably, corrosion resistant material of the first and/or second cladding comprises a corrosion resistance alloy.

In exemplary embodiments, corrosion resistance alloy is metallurgically bonded to the inner surface of the first tubular.

Preferably, the corrosion resistance alloy of the first cladding comprises 316L (UNS S301603), 904L (UNS N08904), 6Mo (UNS N08367) or Alloy 825 (UNS N08825).

Preferably, the corrosion resistance alloy of the second cladding comprises Alloy 625.

In exemplary embodiments, the tubular assembly comprises a third cladding comprising a corrosion resistant material along the inner surface of the second iron-based tubular and a fourth cladding comprising a corrosion resistant material along the inner surface of the second iron-based tubular; the fourth cladding being adjacent the third cladding and proximate an end of the second iron-based tubular connected to the first iron-based tubular by the non-iron based bonding material.

Preferably, the first cladding and the third cladding comprise the same corrosion resistant material. It is also preferred that the second cladding and the fourth cladding comprise the same corrosion resistant material.

In exemplary embodiments, the non-iron based bonding material comprises a nickel based alloy.

Preferably, the bonding material has a higher nickel content than the first or second iron-based tubular.

Preferably, the bonding material comprises a lower iron content than the first or second iron-based tubular.

Preferably, wherein the first and/or second iron-based tubular comprises carbon steel.

In exemplary embodiments, the first and second iron-based tubulars comprise a pipe joint.

In embodiments, wherein the first and second iron-base tubulars comprise a pipe joint, preferably the tubular assembly is a steel catenary riser.

According to a second aspect, there is provided a method of producing a tubular for a tubular assembly for conveying corrosive fluid, comprising:
obtaining an iron-based tubular having a cladded inner surface, said cladded inner surface comprising a first cladding comprising a corrosion resistant material along the inner surface of the iron-based tubular;
preparing and beveling one or both ends of the iron-based tubular for bonding to another iron-based tubular;
removing an area of the first cladding proximate the end of the iron-based tubular to be bonded to the other iron-based tubular;
replacing the removed area of the first cladding with a second cladding, said second cladding comprising a corrosion resistant material.

Preferably, corrosion resistant material of the first and second cladding comprises a corrosion resistance alloy.

Preferably, the corrosion resistance alloy of the first cladding comprises 316L, 904L, 6Mo or Alloy 825.

Preferably, the area of the first cladding is removed by machining.

Preferably, the corrosion resistance alloy of the second cladding comprises Alloy 625.

Preferably, the removed area of the first cladding is replaced by the second cladding by using a weld overlay process.

In exemplary embodiments wherein the removed area of the first cladding is replaced by the second cladding by using a weld overlay process, the method further comprises machining and grinding the weld overlay to merge the second cladding with the first cladding.

Preferably, the iron-based tubular comprises carbon steel.

According to a third aspect, there is provided a method of manufacturing a tubular assembly for conveying corrosive fluid, comprising:
providing a first iron-based tubular having a cladded inner surface; said cladded inner surface comprising a first cladding comprising a corrosion resistant material along the inner surface of the first iron-based tubular, and a second cladding comprising a corrosion resistant material along the inner surface of the first iron-based tubular, the second cladding being adjacent the first cladding and proximate an end of the first iron-based tubular;
providing a second iron-based tubular having a cladded inner surface;
bonding the end of the first iron-based tubular proximate the second cladding to an end of said second iron based tubular using a non-iron based bonding material.

Preferably, first iron-based tubular is a tubular produced in accordance with the second aspect of the invention.

Preferably, the cladded inner surface of the second iron-based tubular comprises a third cladding comprising a corrosion resistant material along the inner surface of the second iron-based tubular, and a fourth cladding comprising a corrosion resistant material along the inner surface of the second iron-based tubular, the fourth cladding being adjacent the third cladding and proximate an end of the second iron-based tubular.

Preferably, the second iron-based tubular is a tubular produced in accordance with the second aspect of the invention.

Preferably, the end of the first iron-based tubular proximate the second cladding is bonded to the end of the second iron-based tubular proximate the fourth cladding.

Preferably, the non-iron based bonding material comprises a nickel-based alloy.

In exemplary embodiments, the first and second iron-based tubulars comprise a pipe joint.

The invention will now be described by way of non-limiting example, with reference being made to the accompanying drawings, in which:

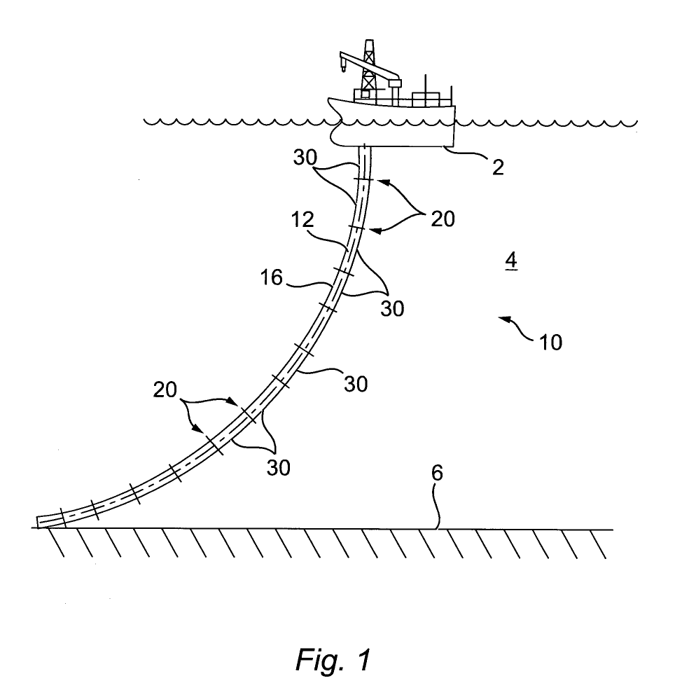

FIG. 1 is a diagrammatic side view of a tubular assembly in accordance with the invention adapted to convey fluid to a floating platform;

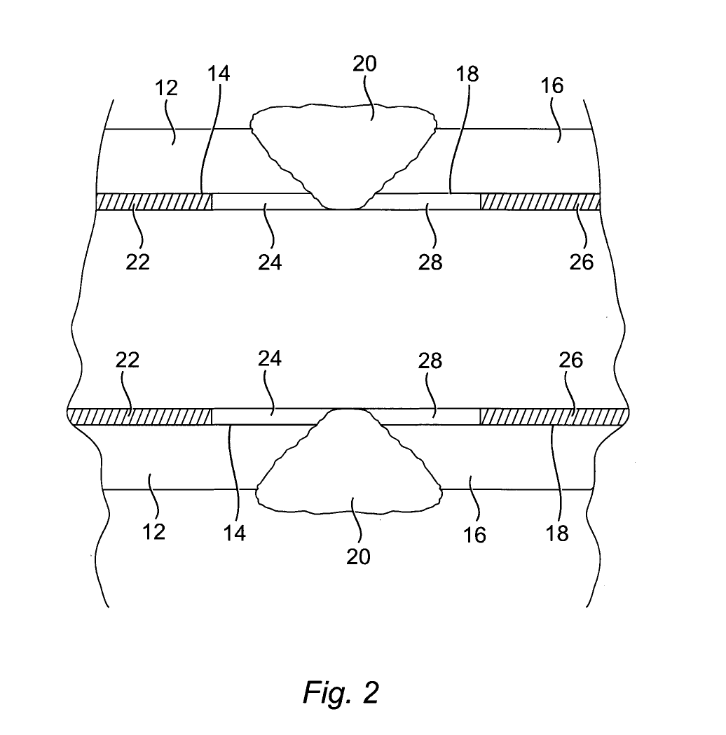

FIG. 2 is a partial cross sectional view of an embodiment of a tubular assembly in accordance with the invention; and

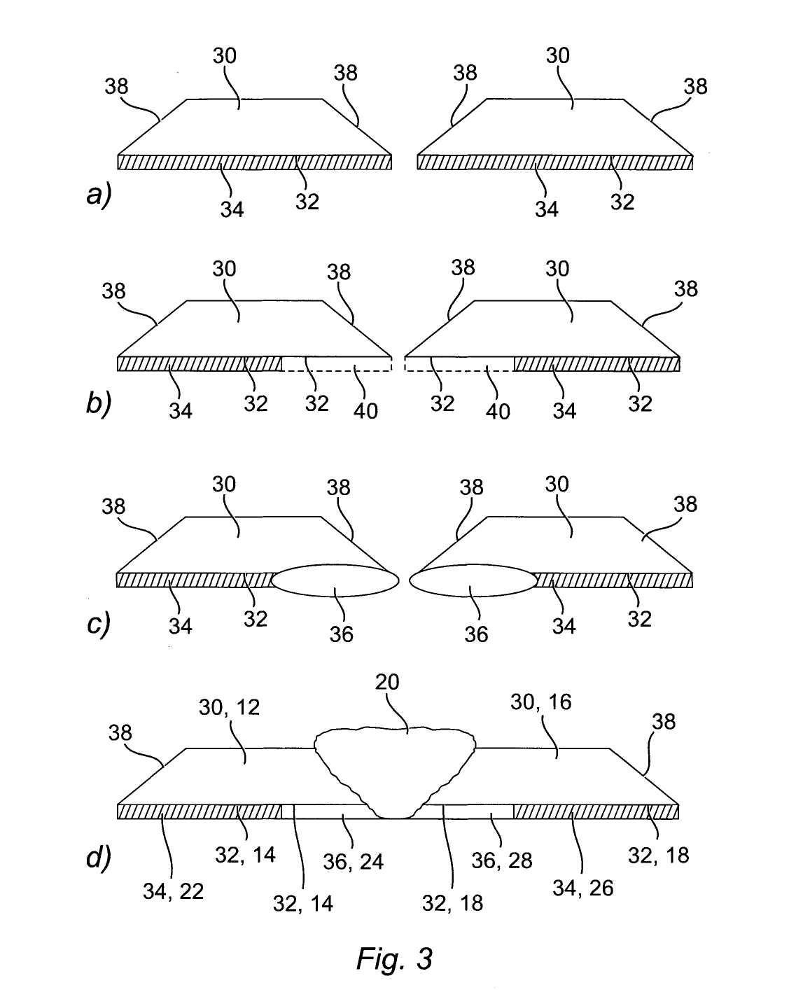

FIG. 3 shows diagrammatic views of the preparation and connection of two adjoining tubulars forming part of the tubular assembly of FIG. 2.

The preceding discussion of the background to the invention is intended only to facilitate an understanding of the present invention. It should be appreciated that the discussion is not an acknowledgement or admission that any of the material referred to was part of the common general knowledge as at the priority date of the application.

Throughout the description and claims of this specification, the words “comprise” and “contain” and variations of the words, for example “comprising” and “comprises”, mean “including but not limited to”, and is not intended to (and does not) exclude other components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics, compounds described in conjunction with a particular aspect, embodiment or example of the invention are to be understood to be applicable to any other aspect, embodiment or example described herein unless incompatible therewith.

The term “tubular” means a fluid conduit having an axial bore, and includes, but is not limited to, a riser, a casing, a production tubing, a liner, and any other type of wellbore tubular known to a person of ordinary skill in the art.

As used herein, the term “bond” refers to any type of connection that is used to connect tow metals, and includes, but is not limited to, a weld.

The term “cladding” means a layer of material, and includes, but is not limited to, a tubular sleeve, an arcuate sheath, and a deposited layer of material.

The term “iron based” means a material whose characteristics are determined by its iron content. An exemplary iron based material includes a material having an iron content of at least about 50%.

The term “non-iron based” means a material whose characteristics are determined by an element other than iron. An exemplary non-iron based material includes a material having an iron content of less than about 50%. Another exemplary non-iron based material includes nickel based alloy.

The term “nickel based alloy” means an alloy having at least about 40% nickel content; more preferably, at least about 50% nickel content.

The term “riser” means a pipe that connects a subsea pipeline to a floating surface structure.

Referring to FIG. 1, an embodiment of a tubular assembly 10 in accordance with the invention conveying fluid to a floating platform 2 is shown. The tubular assembly 10 extends from the floating platform 2 towards the bottom of a sea 4 and onto a seabed 6.

In the embodiment shown, the floating platform 2 is in the form of a floating production storage and offloading unit, although it would be understood that the floating platform may be of a different form as known in the art.

Referring to FIG. 2, a partial cross sectional view of the tubular assembly 10 is shown. The tubular assembly 10 comprises a first iron-based tubular 12 having a cladded inner surface 14 and a second iron-based tubular 16 having a cladded inner surface 18. The first tubular 12 is connected to the second tubular 16 using a non-iron based bonding material 20. In the embodiment shown, the first tubular 12 is connected to the second tubular 16 by means of a girth weld.

The tubular assembly 10 comprises a first cladding 22 comprising a corrosion resistant material along the inner surface 14 of the first iron-based tubular 12 and a second cladding 24 comprising a corrosion resistant material along the inner surface 14 of the first iron-based tubular 12. The second cladding 24 is adjacent the first cladding 22 and proximate an end of the first iron-based tubular 12 connected to the second iron-based tubular 16 by the non-iron based bonding material 20.

The corrosion resistant material of the first and second cladding 22, 24 comprises a corrosion resistance alloy which is metallurgically bonded to the inner surface 14 of the first tubular 12.

The corrosion resistance alloy of the second cladding 24 comprises Alloy 625 and the corrosion resistance alloy of the first cladding 22 comprises an alloy that is less expensive than Alloy 625. For example, the corrosion resistant alloy of the first cladding 22 may comprise 316L, 904L, 6Mo or Alloy 825.

The tubular assembly 10 further comprises a third cladding 26 comprising a corrosion resistant material along the inner surface 18 of the second iron-based tubular 16 and a fourth cladding 28 comprising a corrosion resistant material along the inner surface 18 of the second iron-based tubular 16. The fourth cladding 28 is adjacent the third cladding 26 and proximate an end of the second iron-based tubular 16 connected to the first iron-based tubular 12 by the non-iron based bonding material 20.

In the embodiment shown, the first cladding 22 and the third cladding 26 comprise the same corrosion resistant material, and the second cladding 24 and the fourth cladding 28 comprise the same corrosion resistant material. It would be understood that the first and third cladding 22, 26 may comprise different corrosion resistant materials. Likewise, the second and fourth cladding 24, 28 may comprise different corrosion resistant materials.

The non-iron based bonding material 20 comprises a nickel based alloy which has a higher nickel content than the first or second iron-based tubular 12,16 and a lower iron content than the first or second iron-based tubular 12, 16. For example, the nickel based alloy may comprise a nickel-chromium-molybdenum alloy.

In embodiment shown, the tubular assembly 10 is in the form of a steel catenary riser and the first and second iron-based tubulars 12, 16 comprise carbon steel pipe joints.

A plurality of pipe joints 30 having the same features of as the first or second tubular 12, 16 are connected together to produce the steel catenary riser.

Referring to FIGS. 3a to 3c, the method of producing a tubular for a tubular assembly 10 in accordance with the invention will now be described.

Firstly, a pipe joint 30 in the form of an iron-based tubular having a cladded inner surface 32 is obtained. The cladded inner surface 32 comprises a first cladding 34 comprising a corrosion resistant material along the inner surface 32 of the iron-based tubular.

For example, as in the case of the first tubular 12 described above, the corrosion resistant material comprises a corrosion resistance alloy comprising 316L, 904L, 6Mo or Alloy 825.

One or both ends 38 of the iron-based tubular 30 are then prepared and beveled for bonding to another iron-based tubular 30 (see FIG. 3a).

After one or both ends 38 are prepared and beveled, an area 40 of the first cladding 34 proximate the end 38 of the iron-based tubular 30 to be bonded to the other iron-based tubular 30 is removed (see FIG. 3b).

The area 40 of the first cladding 34 is removed by any suitable means, for example, the area 40 of the first cladding 34 may be removed by machining.

The removed area 40 of the first cladding 34 is then replaced with a second cladding 36 comprising a corrosion resistant material. As, in the case of the first tubular 12 described above, the corrosion resistant material of the second cladding comprises a corrosion resistance alloy comprising Alloy 625.

The removed area of the first cladding is replaced by the second cladding by any suitable means. A preferred method is by using a weld overlay process.

Where the weld overlay process is utilized, the weld overlay is machined and grinded to merge the second cladding 34 with the first cladding 36.

In order to manufacture the tubular assembly 10 in accordance with the invention, pipe joints/tubulars 30 for forming the tubular assembly 10 are produced/prepared as described above.

The two tubulars 30 are then bonded together using a non-iron based bonding material 20 at their respective ends proximate the second cladding 36 (see FIG. 3d).

Further tubulars 30 are bonded to a free end of the assembled tubulars 30 as required until the tubular assembly 10 is of the required length.

The end 38 of each tubular 30 to be bonded to the other tubular 30 will be prepared as described above so as to have the second cladding 36 proximate the end 38 to be bonded.

1. A tubular assembly for conveying corrosive fluid comprising:
a first iron-based tubular having a cladded inner surface; and
a second iron-based tubular having a cladded inner surface; the first tubular being connected to the second tubular using a non-iron based bonding material; wherein the tubular assembly comprises a first cladding comprising a corrosion resistant material along the inner surface of the first iron-based tubular and a second cladding comprising a corrosion resistant material along the inner surface of the first iron-based tubular; the second cladding being adjacent the first cladding and proximate an end of the first iron-based tubular connected to the second iron-based tubular by the non-iron based bonding material.

2. The tubular assembly according to claim 1, wherein the first cladding comprises 316L, 904L, 6Mo or Alloy 825.

3. The tubular assembly according to claim 1, wherein the second cladding comprises Alloy 625.

4. The tubular assembly according to claim 1, wherein the tubular assembly comprises a third cladding comprising a corrosion resistant material along the inner surface of the second iron-based tubular and a fourth cladding comprising a corrosion resistant material along the inner surface of the second iron-based tubular; the fourth cladding being adjacent the third cladding and proximate an end of the second iron-based tubular connected to the first iron-based tubular by the non-iron based bonding material.

5. The tubular assembly according to claim 4, wherein the first cladding and the third cladding comprise the same corrosion resistant material.

6. The tubular assembly according to claim 4, wherein the second cladding and the fourth cladding comprise the same corrosion resistant material.

7. The tubular assembly according to claim 1, wherein the non-iron based bonding material comprises a nickel based alloy.

8. The tubular assembly according to claim 1, wherein the bonding material has a higher nickel content than the first or second iron-based tubular.

9. The tubular assembly according to claim 1, wherein the bonding material comprises a lower iron content than the first or second iron-based tubular.

10. The tubular assembly according to claim 1, wherein the first and/or second iron-based tubular comprises carbon steel.

11. The tubular assembly according to claim 1, wherein the first and second iron-cased tubulars comprise a pipe joint.

12. The tubular assembly according to claim 1, wherein the tubular assembly is a steel catenary riser.

13. A method of producing a tubular for a tubular assembly for conveying corrosive fluid, comprising:
obtaining an iron-based tubular having a cladded inner surface, said cladded inner surface comprising a first cladding comprising a corrosion resistant material along the inner surface of the iron-based tubular;
preparing and beveling one or both ends of the iron-based tubular for bonding to another iron-based tubular;
removing an area of the first cladding proximate the end of the iron-based tubular to be bonded to the other iron-based tubular; and
replacing the removed area of the first cladding with a second cladding, said second cladding comprising a corrosion resistant material.

14. The method according to claim 13, wherein the first cladding comprises 316L, 904L, 6Mo or Alloy 825; and the area of the first cladding is removed by machining.

15. The method according to claim 13, wherein the second cladding comprises Alloy 625.

16. The method according to claim 13, wherein the removed area of the first cladding is replaced by the second cladding by using a weld overlay process.

17. The method according to claim 16, further comprising machining and grinding the weld overlay to merge the second cladding with the first cladding.

18. The method according to claim 13, wherein the iron-based tubular comprises carbon steel.

19. A method of manufacturing a tubular assembly for conveying corrosive fluid, comprising:
providing a first iron-based tubular having a cladded inner surface; said cladded inner surface comprising a first cladding comprising a corrosion resistant material along the inner surface of the first iron-based tubular, and a second cladding comprising a corrosion resistant material along the inner surface of the first iron-based tubular, the second cladding being adjacent the first cladding and proximate an end of the first iron-based tubular;
providing a second iron-based tubular having a cladded inner surface; and
bonding the end of the first iron-based tubular proximate the second cladding to an end of said second iron based tubular using a non-iron based bonding material.

20. The method according to claim 19, further comprising, the providing of the first iron-based tubular comprises producing the first tubular by
obtaining an iron-based tubular having a cladded inner surface, said cladded inner surface comprising a first cladding comprising a corrosion resistant material along the inner surface of the iron-based tubular;
preparing and beveling one or both ends of the iron-based tubular for bonding to another iron-based tubular;
removing an area of the first cladding proximate the end of the iron-based tubular to be bonded to the other iron-based tubular; and
replacing the removed area of the first cladding with a second cladding, said second cladding comprising a corrosion resistant material.

21. The method according to claim 19, wherein cladded inner surface of the second iron-based tubular comprises a third cladding comprising a corrosion resistant material along the inner surface of the second iron-based tubular, and a fourth cladding comprising a corrosion resistant material along the inner surface of the second iron-based tubular, the fourth cladding being adjacent the third cladding and proximate an end of the second iron-based tubular.

22. A method according to claim 21, further comprising, the providing of the second iron-based tubular comprises producing the second tubular by providing
a second iron-based tubular having a second cladded inner surface, said second cladded inner surface comprising a second cladding comprising a corrosion resistant material along the inner surface of the second iron-based tubular;
preparing and beveling one or both ends of the second iron-based tubular for bonding to another iron-based tubular;
removing an area of the second cladding proximate the end of the iron-based tubular to be bonded to the other iron-based tubular; and
replacing the removed area of the second cladding with a third cladding, said third cladding comprising a corrosion resistant material.

23. A method according to claim 21, wherein the end of the first iron-based tubular proximate the second cladding is bonded to the end of the second iron-based tubular proximate the fourth cladding.

24. A method according to claim 19, wherein the non-iron based bonding material comprises a nickel-based alloy.

25. A method according to claim 19, wherein the first and second iron-based tubulars comprise a pipe joint.
